(19) United States
(12) Patent Application Publication
(10) Pub. No.: US 2016/0275121 A1
(43) Pub. Date: Sep. 22, 2016

(54) MERGING DATA FROM A SOURCE TABLE INTO A TARGET TABLE

(71) Applicant: HEWLETT PACKARD ENTERPRISE DEVELOPMENT LP, Houston, TX (US)

(72) Inventors: Jaimin Mukesh DAVE, Cambridge, MA (US); Nga TRAN, Cambridge, MA (US); Sreenath BODAGALA, Cambridge, MA (US)

(21) Appl. No.: 15/033,537

(22) PCT Filed: Dec. 2, 2013
(86) PCT No.: PCT/US2013/072650

§ 371 Date: Apr. 29, 2016

(51) Int. Cl. G06F 17/30

(52) U.S. Cl. CPC G06F 17/30339; G06F 17/30377; G06F 17/30498

(57) ABSTRACT

In an example, data from a source location is merged into a target location, in which both the source location and the target location contain tuples of data. A matched tuple in the target table that matches a The deleting of the tuple in the target table includes executing a semi inner join operation between the source table and the target table to identify the matched tuple. Each tuple contained in the source table may be inserted into the target table as a new tuple.

### BACKGROUND

Loading new data into existing tables is a process commonly performed for most databases. New data is typically loaded into existing tables to ensure that the data contained in the tables is up to date. The new data often includes both data that is new and data that is an update to existing data. Existing methods for loading the data typically employ two separate operations, one operation to load updated data and another operation to load new data.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a machine that may implement a merge operation, according to an example of the present disclosure;

FIG. 2 shows a diagram of a merge operation between a source table and a target table, according to an example of the present disclosure;

FIG. 3 shows a flow diagram of a method to merge data from a source table into a target table, in which both the source table and the target table contain tuples of data, according to an example of the present disclosure; and

FIG. 4 shows a flow diagram of a method to merge data from a source table into a target table, in which both the source table and the target table contain tuples of data, according to a further example of the present disclosure; and

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Disclosed herein are methods for merging data from a source table into a target table, in which both the source table and the target table contain tuples of data. Also disclosed herein are an apparatus for implementing the methods and a non-transitory computer readable medium on which is stored machine readable instructions that implement the methods. Methods for merging data include a merge operation, which may be implemented or invoked in a Vertica™ column-stored database or other types of databases. The merge operation of the present disclosure may perform both an update to existing data and an insertion of new data in the target table during a single merge operation.

According to an example, a single merge operation of the present disclosure may be implemented as a delete operation and an insert operation executed in parallel to update existing data and insert new data in the target table. As such, compared with other merge operations, which require a right outer join operation to insert updated and new tuples into the target table, the merge operation of the present disclosure provides a more efficient manner of merging data into the target table. For example, the insert operation of the merge operation of the present disclosure does not require a join operation or input from a join operation, and thus the insert operation may be implemented in parallel with the delete operation to reduce execution time for the merge operation. According to an example, the insert operation may insert both matched and unmatched tuples contained in the source table into the target table as new tuples. Therefore, according to examples of the present disclosure, the merge operation may only require one insert operation, as opposed to separate insert operations for updated tuples and new tuples as required in other merge operations.

According to an example of the present disclosure, the delete operation may delete a tuple in the target table that matches a tuple in the source table based on a predetermined condition. The matched tuple may, for instance, be an existing tuple in the target table to be updated. The existing tuple in the target table may be identified as a matched tuple by executing a late materialized join operation between the source table and the target table. By implementing a late materialization strategy and delaying the materialization of the matched tuple, the position of the matched tuple in the target table may be preserved for later processing by the delete operation. The position of the matched tuple for example is the location of the matched tuple in a merged target table. The location may be the position of the tuple's row in the merged target table.

For a late materialized join operation between the source and the target table, the position of the rows from the target table are preserved. By doing this, the target table does not have to be rescanned to find the position of the rows that are to be marked as deleted in a delete vector. An early materialized join operation reads all the columns of a table before a join operation, and thus does not need to preserve the position of the rows because all the data from the column has been read. In contrast, in a late materialized join operation reads only the join columns before the join operation and fetches the rest of the non-join columns only after passing the join operation. That is, in a late materialized join operation, non-join columns are fetched using position of the rows that passed join operation.

Examples of the present disclosure implement a late materialized join operation, whereby the position of the matched tuple may be preserved for addition to a delete vector without an additional scan of the target table. In one example, the merge operation of the present disclosure may only scan the target table once during the initial join operation, which improves the performance and speed of the merge operation. In contrast, other update operations typically employ an early materialization strategy, which does not preserve the position of the matched tuples. Thus, other update operations (which include delete operations) require an additional scan (e.g., join operation) of the target table to fetch the position of matched tuples before deleting and updating the matched tuples. This additional scan is computationally expensive in terms of the performance and speed for other merge operations.

A merge operation of the present disclosure may utilize a semi inner join operation to identify tuples in the target table that match tuples in the source table based on a predetermined condition. Compared with other merge operations, which typically utilize a right outer join operation, the merge operation of the present disclosure provides a less restrictive and less computationally expensive semi inner join operation for identifying the matched tuples. Moreover, by utilizing a semi inner join operation, the merge may ignore unmatched tuples. Accordingly, in contrast to other merge operations, the merge operation of the present disclosure may not differentiate between matched and unmatched tuples when inserting the tuples into the target table, which results in a relatively faster merge operation as discussed in greater detail herein.

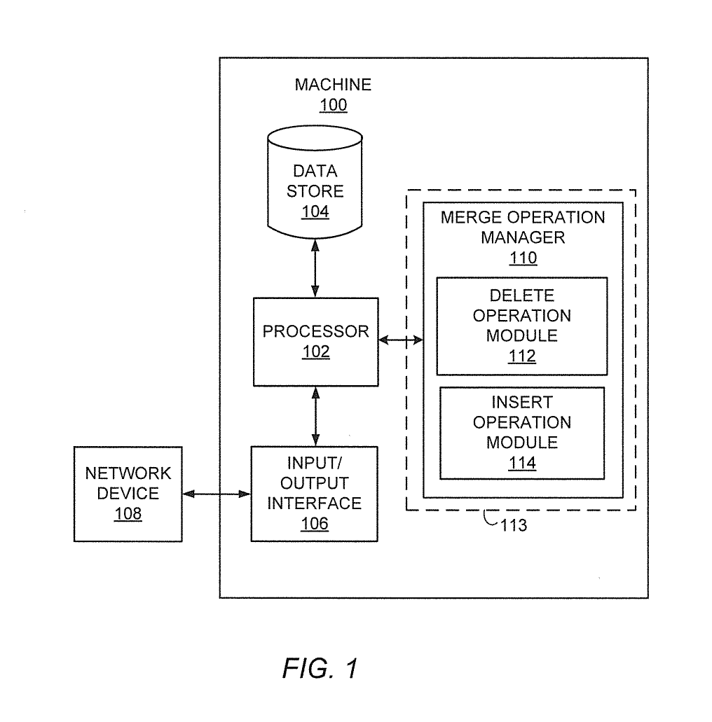

With reference to FIG. 1, there is shown a block diagram of a machine 100 that may implement the merge operation according to an example of the present disclosure. It should be understood that the machine 100 may include additional components and that one or more of the components described herein may be removed and/or modified without departing from a scope of the machine 100.

The machine 100 is depicted as including a processor 102, a data store 104, an input/output interface 106, and a merge operation manager 110. The machine 100 comprises a computer. In one example, the computer is a server but other types of computers may be used. Also, the components of the machine 100 are shown on a single computer as an example and in other examples the components may exist on multiple computers. The machine 100 may store a target table and/or may manage the storage of data in a target table stored in a separate machine, for instance, through a network device 108, which may comprise, for instance, a router, a switch, a hub, etc.

The merge operation manager 110 is depicted as including a delete operation module 112 and an insert operation module 114. The processor 102, which may comprise a microprocessor, a micro-controller, an application specific integrated circuit (ASIC), or the like, is to perform various processing functions in the machine 100. The processing functions may include the functions of the modules 112 and 114 of the merge operation manager 110 as discussed in greater detail herein below.

In one example, the merge operation manager 110 comprises machine readable instructions stored on a non-transitory computer readable medium 113 and executed by the processor 102. Examples of the non-transitory computer readable medium include dynamic random access memory (DRAM), electrically erasable programmable read-only memory (EEPROM), magnetoresistive random access memory (MRAM), Memristor, flash memory, hard drive, and the like. In another example, the merge operation manager 110 comprises a hardware device, such as a circuit or multiple circuits arranged on a board. In this example, the modules 112 and 114 comprise circuit components or individual circuits, such as an embedded system or ASIC.

The input/output interface 106 comprises a hardware and/or a software interface. In any regard, the input/output interface 106 may be connected to a network, such as the Internet, an intranet, etc., through the network device 108, over which the merge operation manager 110 may receive and communicate information, for instance, the data contained in the source table 110 and data contained in other tables. The processor 102 may store information received through the input/output interface 106 in the data store 104 and may use the information in implementing the modules 112 and 114. The data store 104 may include volatile and/or non-volatile data storage.

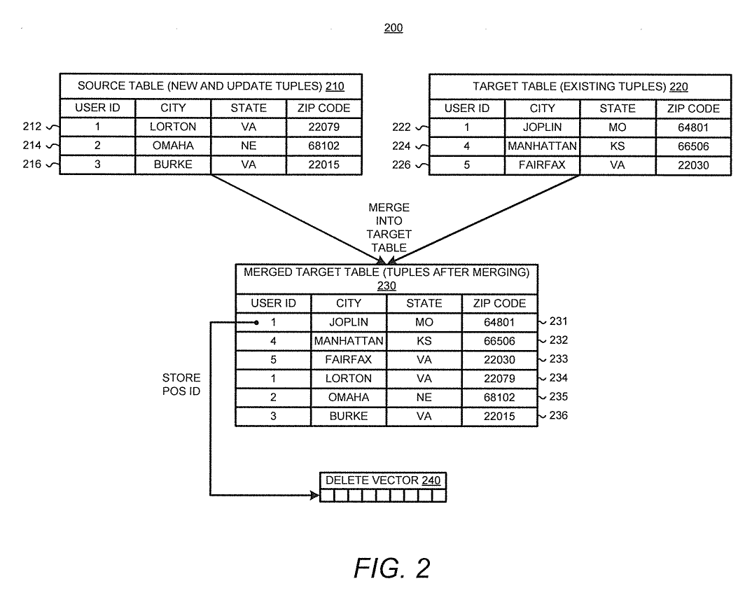

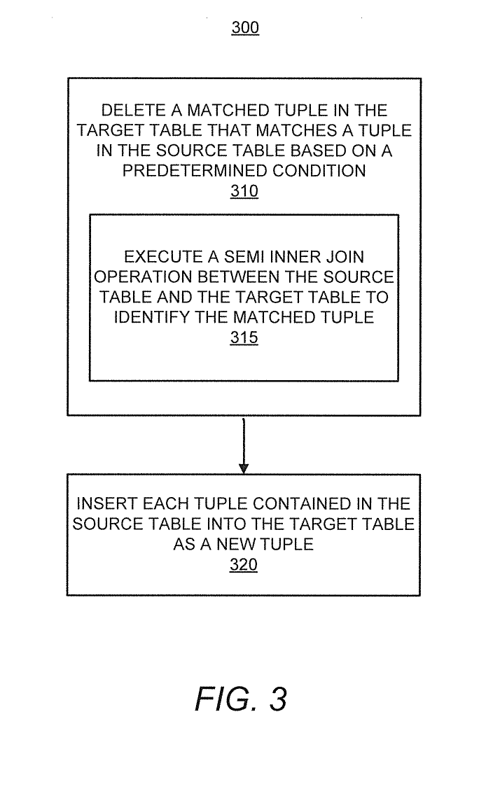

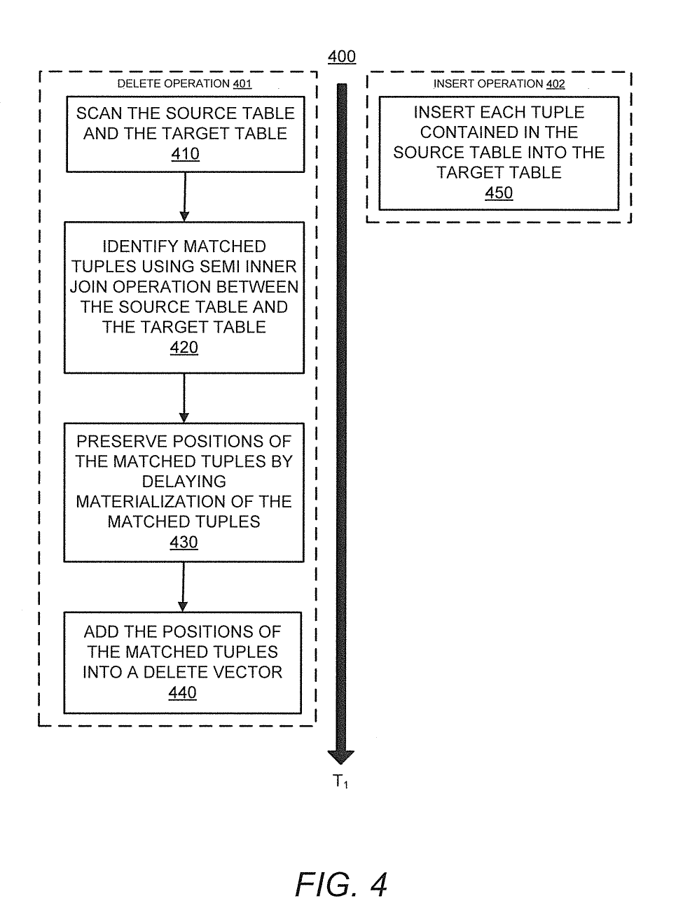

The delete operation module 112 and the insert operation module 114 perform delete and insert operations for merge operations described herein. Examples of the merge operations are discussed in greater detail with respect to FIG. 2 and the methods 300 and 400 depicted in FIGS. 3 and 4.

With reference first to FIG. 2, there is shown a diagram 200 of a merge operation between a source table 210 and a target table 220, according to an example of the present disclosure. It should be understood that the data depicted in FIG. 2 is for purposes of illustration only. In addition, the data depicted in FIG. 2 is used in various examples throughout the present disclosure to provide an understanding of the merge operation of the present disclosure.

As shown in FIG. 2, the data contained in a source table 210 may be merged into the data contained in a target table 220 to generate a merged target table 230. For example, the merged target table 230 is the target table 220 that has been updated with tuples from the source table 210. The tables may be stored in the same node or different nodes. Nodes may include different machines, different databases, etc. In any regard, because the target table 220 may typically contain a larger amount of data than the source table 210, the data contained in the source table 210 may be merged into the target table 220. In this regard, the merged table 230 may comprise an updated version of the data contained in the target table 220.

Although the source table 210 and the target table 220 have been depicted as having the same number of columns, it should be understood that various aspects of the present disclosure may be implemented in source tables and target tables having different numbers of columns and data types. In one regard, therefore, various aspects of the present disclosure may be implemented with source and target tables that are not the same schema.

A query to merge the source table 210 and the target table 220 into the merged target table 230, as shown in FIG. 2, may include the following SQL commands:

MERGE INTO Source using Target on Source.USERID=Target.USERID;

when matched then update

set USERID=Source.USERID, CITY=Source.CITY, STATE=Source.STATE, ZIPCODE=Source.ZIPCODE;

when not matched then

insert (USERID, CITY, STATE, ZIPCODE) values (Source.USERID, Source.CITY, Source.STATE, Source.ZIPCODE).

As discussed in greater detail herein, the update clause and the insert clause of the query above may be performed by an example merge operation including a delete operation in parallel with an insert operation. For example, the query above may be converted into an example merge operation with following SQL commands:

DELETE from Target where exists (select 1 from Source where Target.USERID=Source.USERID);

INSERT into Target as select USERID, CITY, STATE, ZIPCODE from Source.

As shown in FIG. 2, the data contained in each of the source table 210 and the target table 220 is depicted as being arranged in tables formed of respective tuples, in which, each of the tuples includes by way of example a user identification (UserID), a city, a state, and a zip code. In FIG. 2, the source table 210 includes tuples 212-216. In this example, the tuple 212 in the source table 210 is depicted as matching the tuple 222 in the target table 220 according to the merge operation. For instance, a predetermined condition in this example defines that the tuples in the source table 210 match the tuples in the target table 220 if the UserID fields are the same. Therefore, since the UserID of tuple 212 and tuple 222 are the same, they are considered as matched tuples according to this example. In addition, the remaining two tuples 214 and 216 in the source table 210 are depicted as not matching any of the tuples 222-226 in the target table 220.

Because tuples 212 and 222 match, the tuple 222 in the target table 220 may be deleted by adding its position identification (PosID) to a delete vector 240. For example, the PosID may be a row ID or row number. The delete vector 240, for instance, may keep track of the address of the deleted tuple 222 in the target table 220 as the PosID. Moreover, according to an example of the merge operation, both the matched tuple 212 of the source table and the unmatched tuples 214, 216 may be inserted into the merged target table 230 in parallel, e.g., simultaneously, with the deletion of tuple 231 in the merged target table 230. Also, the delete vector 240 identifies the deleted tuples but the deleted tuples may not actually be deleted from the tables. However, if a tuple is in the delete vector 240, the tuple may not be used for database operations. For instance, a deleted tuple identified in the delete vector 240 is not retrieved for a read operation but still may be stored in the database table.

As discussed above, the update clause and the insert clause of the original merge query may be converted into the example merge operation to perform a delete operation in parallel with an insert operation. According to the converted commands of the example merge operation, the insert operation does not require a join operation or input from a join operation, and thus may be implemented in parallel with the delete operation to reduce execution time for the merge operation. Moreover, the matched tuple 222 in the target table 220 may be identified as a matched tuple using a late materialized join operation between the source table 210 and the target table 220.

By implementing a late materialization strategy and delaying the materialization of the matched tuple 222, the position of the matched tuple 222 in the target table 220 may be preserved for addition to the delete vector 240 without an additional scan of the target table. For example, the merge operation may only scan the target table once during an initial join operation, which improves the performance and speed of the merge operation.

Further, the merge operation may utilize a semi inner join operation to identify the matched tuple 222 in the target table 220 based on a predetermined condition. As such, the merge operation may ignore the unmatched tuples 224, 226 in the target table 220 and does not differentiate between matched and unmatched tuples when inserting the tuples 112, 114, 116 contained in the source table 210 into the merged target table 230, which results in a relatively faster merge operation. The result of the merge operation is represented by tuples 231-236 in the merged target table 230 shown in FIG. 2.

FIGS. 3 and 4, respectively depict flow diagrams of methods 300 and 400 for merging data from a source table into a target table containing existing data, according to examples of the present disclosure. It should be apparent to those of ordinary skill in the art that the methods 300 and 400 represent generalized illustrations and that other operations may be added or existing operations may be removed, modified or rearranged without departing from the scopes of the methods 300 and 400. The method 400 is related to the method 300 in that method 400 includes operations in addition to those included in the method 300. Thus, the method 400 may be construed as including all of the features discussed with respect to the method 300.

With reference to FIG. 3, there is shown a flow diagram of a method 300 for merging data from a source table into a target table, in which both the source table and the target table contain tuples of data, according to an example of the present disclosure. The method 300 may be implemented, for instance, by the processor 102 of machine 100 as depicted in FIG. 1.

In FIG. 3, at block 310, a delete operation may be performed to delete a tuple in a target table that matches a tuple in a source table based on a predetermined condition, for instance, by the delete operation module 112. The matched tuple in the target table, for instance, may be an existing tuple that is to be updated during the merge operation. The determination as to whether there is a matched tuple in the target table for each tuple in the source table may be made during a scan of each of the source table and the target table. In addition, the predetermined condition may comprise that the data contained in selected ones of the columns match (i.e., are the same). Thus, in instances where the source table contains a different number of columns than the target table, tuples may be considered as matching when less than all of the data contained in the columns of the source table and the target table match, so long as the data contained in predetermined ones of the columns match each other.

According to an example, as shown in block 315, the delete operation of block 310 may first identify a tuple in the target table as a matched tuple based on a predetermined condition by utilizing a semi inner join operation between the source table and the target table. According to an example, the late materialized, semi inner join operation may not construct tuples until after the join operation, thus allowing the delete operation, for instance, to operate directly on a column of positions of the scanned tuples as long as possible. That is, a position of the matched tuple in the target table may be preserved and received from the late materialized join operation. Accordingly, the preserved position of the matched tuple in the target table may be added to a delete vector without an additional scan of the target table according to an example.

At block 320, an insert operation may be performed to insert each tuple contained in the source table into the target table as a new tuple, for instance, by the insert operation module 114. According to an example, the insert operation may be performed in parallel with the delete operation depicted in block 310. That is, the insert operation may not require a join operation or input from a join operation in order to insert each tuple contained in the source table into the target table. Accordingly, the insert operation does not differentiate between matched tuples and unmatched tuples, and thus, the inserting of each tuple from the source table into the target table may be implemented without identifying matched tuples. According to an example, the unmatched tuples from the source table may be new tuples. The insert operation of an example, therefore, may insert both matched tuples and unmatched tuples contained in the source table into the target table as new tuples.

As discussed above with respect to the diagram 200 depicted in FIG. 2, the predetermined condition may require that the UserID of a tuple in the source table 210 be the same as the UserID of a tuple in the target table 220 for the tuple in the source table 210 to be determined as matching a tuple in the target table 220. In addition, the operation at blocks 310 and 315 may result in a determination that the tuple 212 in the source table 210 matches the tuple 222 in the target table 220. By utilizing a late materialized join operation between the source table and the target table, as shown in block 315, a PosID for the matched tuple 231 in the merged target table 230 may be preserved and added to the delete vector 240 to prevent access to the matched tuple from future queries. According to an example, the matched tuple 231 may not be materialized until after the late materialized join operation. Therefore, the late materialized join operation may not discard the position of the matched tuple 231 in the target table prior to the matched tuple 231 being added to the delete vector 240, as further described below. In other words, the position of the matched tuple 231 in the target table may be sustained after the late materialized join operation, in contrast to an early materialization strategy of other merge operations, which typically discards the position of the matched tuple after a join operation.

Moreover, as discussed above with respect to the diagram 200 depicted in FIG. 2, the insert operation of block 320 may be implemented in parallel with the delete operation of block 310 and 315. That is, each tuple 212, 214, and 216 contained in the source table 210 may be inserted into the merged target table 230 regardless of whether the tuples contained in the source table 210 match any tuples in the target table 220.

Turning now to FIG. 4, there is shown a flow diagram of a method 400 for merging data from a source table into a target table, in which both the source table and the target table contain tuples of data, according to another example of the present disclosure. The method 400 may be implemented, for instance, by the processor 102 of machine 100 as depicted in FIG. 1. The method 400 may include a delete operation 401 and an insert operation 402 operating in parallel time (T₁) according to an example. The delete operation 401 may be performed, for instance, by the delete operation module 112 shown in FIG. 1 and the insert operation 402 may be performed, for instance, by the insert operation module 114 shown in FIG. 1.

In FIG. 4, at block 410, the source table and the target table may be scanned. The source table and the target table are scanned to identify the tuples of data contained in each of the source table and the target table. By way of example, the outcome of the scanning of the source table and the target table may be a determination that the source table 210 contains the tuples 212-216 and that the target table 220 contains the tuples 222-226 shown in FIG. 2. According to another example, the scanning may include comparing the tuples from the source table with the tuples from the target table.

At block 420, the source table and the target table are semi inner joined based on a predetermined condition to identify matched tuples. The outcome of the identification at block 420 is a determination as to which tuples in the target table require an update. That is, according to an example, the matched tuples may be marked as removed in the target table to prevent access to the matched tuple in future queries, as further described below.

As discussed above with respect to the diagram 200 depicted in FIG. 2, the predetermined condition may require that the UserID of a tuple in the source table 210 be the same as the UserID of a tuple in the target table 220 for the tuple in the source table 210 to be determined as matching a tuple in the target table 220. In addition, the operation in block 420 may result in a determination that the tuple 212 in the source table 210 matches the tuple 222 in the target table 220. Accordingly, the matched tuple 222 in the target table 220 needs to be updated, and thus, may be deleted by the delete operation 401 as further described below.

At block 430, the position of the matched tuple in the target table may be preserved by delaying materialization of the matched tuples. For example, the positions of the matched tuple in the target table may not be discarded prior to being added to a delete vector, as further described below. In other words, the position of the matched tuple in the target table may be sustained after a join operation, in contrast to an early materialization strategy of other merge operations, which typically discards the position of the matched tuple after a join operation. The semi inner join operation of the identification at block 420 may, for instance, be performed with a late materialization strategy. According to an example, the late materialization strategy may not materialize tuples until after the semi inner join operation, thus allowing the delete operation 401 to operate directly on a column of positions of the scanned tuples as long as possible. Therefore, according to an example, the positions of the matched tuples in the target table may be preserved using the late materialized semi inner join operation.

At block 440, the preserved position of the matched tuple in the target table may be added to a delete vector. By implementing a late materialization strategy and delaying the materialization of the matched tuples, as shown in blocks 420 and 430 of the delete operation 401, the position of matched tuples in the target table are preserved. In contrast to other merge operations that typically use an early materialization strategy, the method 400 of the present disclosure does not require an additional scan (e.g., join) of the target table to fetch the positions of the matched tuples prior to deletion.

According to an example, when adding the positions of the matched tuples to the delete vector, the positions (i.e., address or PosID) of the matched tuples may be marked as removed to prevent access to the matched tuples in future queries. In other words, as described with respect to the method 400, when a delete operation 401 is performed, data is neither physically updated nor removed from the target table. Instead, the existing tuples may be marked as removed in the delete vector and the updated tuples are not updated but newly inserted into the target table.

Turning to the diagram 200 depicted in FIG. 2, the tuple 231 in the merged table 230 is determined to be a matched tuple according to block 420. Since the position of the matched tuple 231 in the merged target table 230 is preserved due to the late materialization strategy employed by the method 400 of the present disclosure, the position (i.e., PosID) of the matched tuple 231 may be added to the delete vector 240. Accordingly, the position of the matched tuple 231 may be marked as removed in the delete vector 240 to prevent access to the matched tuple 231 in future queries.

Referring back to FIG. 4, at block 450, each tuple contained in the source table may be inserted into the target table. According to an example, the insert operation 402 may be performed in parallel with the delete operation 401. That is, the insert operation 402 does not require a join operation or input from a join operation in order to insert each tuple contained in the source table into the target table. In other words, the insert operation 402 may be implemented without identifying matched tuples. Accordingly, the insert operation 402 does not differentiate between matched tuples and unmatched tuples. The unmatched tuples from the source table may be new tuples, for instance. However, the insert operation 402 may insert both matched tuples and unmatched tuples contained in the source table into the target table as new tuples according to an example.

With reference to the diagram 200 depicted in FIG. 2, each tuple 212-216 in the source table 210 is inserted into the merged target table 230 as tuples 234-236. That is, according to the insert operation 402 of the method 400, both matched and unmatched tuples from the source table 210 are inserted into the merged target table 230 in parallel with the delete operation 401.

According to an example, the tuples from the source table may be merged into target projections. Also, the source table may also be a projection. A projection is a set of columns that are either from a table or a join of different tables. In an analytic database, column data is usually stored redundantly in various projections with different column sort orders or data segmentation. This storage mechanism ensures that queries still work when one or more nodes are down, and improves the performance of many different queries. Hence, in the methods 300 and 400, the data in the source table may be merged into a plurality of target projections.

According to an example, the merge operation of the present disclosure may be implemented if the join column is the primary key column of the target table, the insert operation of the update clause is the same as the insert clause of an original MERGE query. The merge operation of the present disclosure may effectively rewrite a merge statement into a delete statement and an insert statement to provide more efficient manner of merging data into a target table

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for merging data from a source table into a target table, wherein both the source table and the target table contain tuples of data, the method comprising:
deleting, by a processor, a matched tuple in the target table that matches a tuple in the source table based on a predetermined condition, wherein the deleting of the matched tuple in the target table includes executing a semi inner join operation between the source table and the target table to identify the matched tuple; and
inserting each tuple contained in the source table into the target table as a new tuple.

2. The method of claim 1, wherein the deleting of the matched tuple in the target table and the inserting of each tuple contained in the source table into the target table are executed in parallel.

3. The method of claim 1, wherein the deleting of the matched tuple in the target table further comprises:
scanning the source table and the target table to determine tuples contained in each of the source table and the target table prior to identifying the matched tuple;
identifying the matched tuple in the target table;
preserving a position of the matched tuple in the target table by delaying materialization of the matched tuple; and
adding the position of the matched tuple to a delete vector without an additional scan of the target table.

4. The method of claim 3, wherein the adding of the position of the matched tuple to the delete vector further comprises marking an address of the matched tuple from the target table as deleted in the delete vector to prevent access to the matched tuple from future queries.

5. The method of claim 1, wherein the inserting of each tuple from the source table into the target table comprises inserting both matched and unmatched tuples contained in the source table into the target table as new tuples.

6. The method of claim 1, wherein the inserting of each tuple from the source table into the target table is implemented without identifying the matched tuple.

7. The method of claim 1, wherein each tuple contained in the source table is inserted into a target projection.

8. An apparatus to merge data from a source location into a target location, wherein both the source location and the target location contain tuples of data, the apparatus comprising:
a processor;
a memory on which is stored machine readable instructions that are to cause the processor to:
delete a matched tuple in the target table that matches a tuple in the source table based on a predetermined condition, wherein the deleting of the matched tuple in the target table includes executing a semi inner join operation between the source table and the target table to identify the matched tuple; and
insert each tuple contained in the source table into the target table as a new tuple, wherein the inserting of each tuple from the source table into the target table is implemented without identifying the matched tuple.

9. The apparatus of claim 8, wherein the machine readable instructions are further to cause the processor to delete the matched tuple in the target table and insert each tuple contained in the source table into the target table in parallel.

10. The apparatus of claim 8, wherein, during the delete of the tuple in the target table, the machine readable instructions are further to cause the processor to:
scan the source table and the target table to determine tuples contained in each of the source table and the target table prior to identifying the matched tuple;
identify the matched tuple in the target table;
preserve a position of the matched tuple in the target table by delaying materialization of the matched tuple; and
add the position of the matched tuple to a delete vector without an additional scan of the target table.

11. The apparatus of claim 8, wherein, during the adding of the position of the matched tuple to the delete vector, the machine readable instructions are further to cause the processor to mark an address of the matched tuple from the target table as deleted in the delete vector to prevent access to the matched tuple from future queries.

12. The method of claim 8, wherein, during the inserting of each tuple from the source table into the target table, the machine readable instructions are further to cause the processor to insert both matched and unmatched tuples contained in the source table into the target table as new tuples.

13. A non-transitory computer readable medium on which is stored machine readable instructions that when executed by a processor, implement a method to merge data from a source location into a target, wherein both the source location and the target location contain tuples of data, the machine readable instructions comprising code to:
delete a matched tuple in the target table that matches a tuple in the source table based on a predetermined condition, wherein the deleting of the matched tuple in the target table includes executing a semi inner join operation between the source table and the target table to identify the matched tuple; and
insert each tuple contained in the source table into the target table as a new tuple, wherein the inserting of each tuple from the source table into the target table is implemented without identifying the matched tuple.

14. The non-transitory computer readable storage medium of claim 13, wherein the machine readable instructions are further to cause the processor to delete the matched tuple in the target table and insert each tuple contained in the source table into the target table in parallel.

15. The non-transitory computer readable storage medium of claim 13, wherein the machine readable instructions are further to cause the processor to:
scan the source table and the target table to determine tuples contained in each of the source table and the target table prior to identifying the matched tuple;
identify the matched tuple in the target table;
preserve a position of the matched tuple in the target table by delaying materialization of the matched tuple; and
add the position of the matched tuple to a delete vector without an additional scan of the target table.
